(19) United States
(12) Patent Application Publication
(10) Pub. No.: US 2011/0110116 A1
(43) Pub. Date: May 12, 2011

(54) Optical Arrangement and Production Method

(75) Inventor: Kimberly Peiler, Canton, MI (US)

(73) Assignee: Osram Opto Semiconductors GmbH, Regensburg (DE)

(21) Appl. No.: 12/918,997

(22) PCT Filed: Feb. 18, 2009
(86) PCT No.: PCT/EP2009/001165

§ 371 Date: Dec. 13, 2010

Related U.S. Application Data
(60) Provisional application No. 61/066,719, filed on Feb. 22, 2008.

(51) Int. Cl. F21V 8/00; B23P 17/04

(52) U.S. Cl. 362/612; 362/617; 362/620; 362/618; 29/592

(57) ABSTRACT

An optical arrangement comprises a light guide and a light source for illuminating the light guide. The light guide comprises a transparent substrate layer and a transparent layer. The light guide has a light extraction surface on a surface of the substrate layer. The transparent layer is arranged on the surface of the substrate layer opposite to the light extraction surface, or the transparent layer is arranged on the light extraction surface of the substrate layer. The transparent layer contains means for improving light extraction. Further, a method for production a light guide is provided.

### FIELD OF THE INVENTION

The invention relates to an optical arrangement which comprises a light guide and a light source for illuminating the light guide. Furthermore, the invention relates to a method for production of a light guide.

### SUMMARY OF THE INVENTION

One object of the invention is to provide an improved optical arrangement comprising a light guide which is very thin and additionally provides a uniform light extraction. A further object of the invention is to provide a production method therefore.

This and other objects are attained in accordance of one aspect of the present invention directed to an optical arrangement comprising a light guide and a light source for illuminating the light guide, wherein the light guide comprises a transparent substrate layer and a transparent layer, the light guide has a light extraction surface on a surface of the substrate layer, the transparent layer is arranged on the surface of the substrate layer opposite to the light extraction surface, or the transparent layer is arranged on the light extraction surface of the substrate layer, and the transparent layer contains means for improving light extraction.

Because of the light guide comprising a transparent substrate layer and a transparent layer wherein the transparent layer contains means for improving light extraction, a very thin light guide with a uniform light extraction can be provided. The light extraction is thereby optimized such that the light extraction of the light guide over the complete light extraction surface is nearly the same.

The light guide has preferably a thickness of less than 300 μm, particularly preferably a thickness of less than 100 μm.

The optical arrangement can advantageously be used as a backlight of keypads or displays. Preferably, the optical arrangement is used as a backlight for cell phone keypads or LCDs (liquid crystal displays). Therefore, it is advantageous that the optical arrangement is very thin, has a high optical efficiency and is very uniform across the light extraction surface.

In one preferred embodiment of the invention, the light source is arranged on a side surface of the light guide.

The light of the light source is accordingly to this coupled to the light guide from the side surface. Therewith, an edge lit light guide can be provided. Thus, the optical arrangement is very thin compared to an optical arrangement comprising a light source which is arranged behind or in front of the light guide. The thickness of the optical arrangement comprising a light source which is coupled to the light guide from the side surface can in that way further get reduced.

The transparent layer contains means for improving light extraction. Thereby, the means for improving light extraction can vary in density alongside the transparent layer. For example, the means for improving light extraction are a prism array.

By the use of means for improving light extraction, the uniformity of the light extraction of the light guide can get optimized. The optimized means for improving light extraction can change in density to be optimized for point light sources, such as for example light emitting diodes (LEDs) or line sources at any side surface of the light guide. The means for improving light extraction extract the light preferably precisely in order to create a uniform backlight.

The means for improving light extraction are for example spherical, pyramidal or triangular holes or bumps. Alternatively, the means for improving light extraction can be means for diffuse scattering, in particular etched dots.

The transparent layer is preferably a curable layer wherein the transparent layer is preferably curable by UV radiation. Preferably, the transparent layer is a polymer layer.

The transparent substrate layer is preferably a plastic film. In one particularly preferably embodiment of the invention, the material of the transparent layer is index matched to the material of the substrate layer. Thus, a preferably thin and flexible light guide can be provided.

In one preferred embodiment of the invention, multiple light sources are arranged on at least one of the side surfaces of the light guide. Multiple light sources can preferably optimize the uniform light extraction of the light guide.

In one particularly preferred embodiment of the invention, the light guide contains means for optical connecting the light source or light sources to the light guide. The means for optical connecting the light source or light sources to the light guide can be, for example, a cutout in the light guide. The cutout can be, for example, a dome wherein the dome is a depression.

A method for production of a light guide comprises the following procedural steps:
providing a transparent substrate layer,
arranging a transparent layer on the surface of the substrate layer opposite to a light extraction surface or arranging a transparent layer on the light extraction surface of the substrate layer,
producing means for improving light extraction on the transparent layer, and
mounting at least one light source on one surface of the light guide.

In this way, a preferably thin light guide can be produced which additionally provides a uniform light extraction. The light guide is, for example, preferably used as a backlight. The light guide is advantageously used as a backlight of keypads or displays, particularly preferably as a backlight for cell phone keypads or LCDs.

The light guide is preferably less than 300 μm thick, particularly preferably less than 100 μm thick.

The means for improving light extraction are preferably cured by UV radiation. In one preferred embodiment of the invention, the means for improving light extraction are produced on the transparent layer by means of embossing. Preferably, the means for improving light extraction are produced on the transparent layer by means of a roll to roll process.

A master for the means for improving light extraction can be replicated and incorporated into a process that is roll to roll. Therefore, large stock rolls of the transparent substrate layer can be used making the light guide useable for mass production. Therewith, the production of the light guide is very economical and very cost effective compared to injection molded light guides or the like. The master can be produced by means of etching.

In one preferred embodiment of the invention, means for optical connecting the light source to the light guide are produced in the light guide, for example by means of stamping or laser cutting.

Thus, the light guide includes means for optical connecting the light source to the light guide, in particular cutouts which can be stamped, laser cut, or otherwise cut, for example from large rolls of an embossed stock sheet. The cutouts in the light guide can be formed as domes, for example.

The invention is explained in more detail below on the basis of exemplary embodiments and the associated FIGS. 1 to 5. The figures show different exemplary embodiments of the invention on the basis of schematic illustrations that are not true to scale. Identical or identically acting parts are designated by the same reference symbols in the Figures.

### BRIEF DESCRIPTION OF THE DRAWINGS

FIG. 1 shows a schematic cross section of an optical arrangement in accordance with a first exemplary embodiment of the invention,

FIG. 2 shows a schematic cross section of an optical arrangement in accordance with a second exemplary embodiment of the invention,

FIG. 3 shows a schematic top view of an optical arrangement in accordance with a third exemplary embodiment of the invention,

FIG. 4 shows a schematic top view of an optical arrangement in accordance with a fourth exemplary embodiment of the invention,

FIGS. 5A, 5B, 5C show schematic perspective views of means for improving light extraction, and

FIG. 6 shows a schematic cross section of an optical arrangement in accordance with a fifth exemplary embodiment of the invention.

### DETAILED DESCRIPTION OF THE DRAWINGS

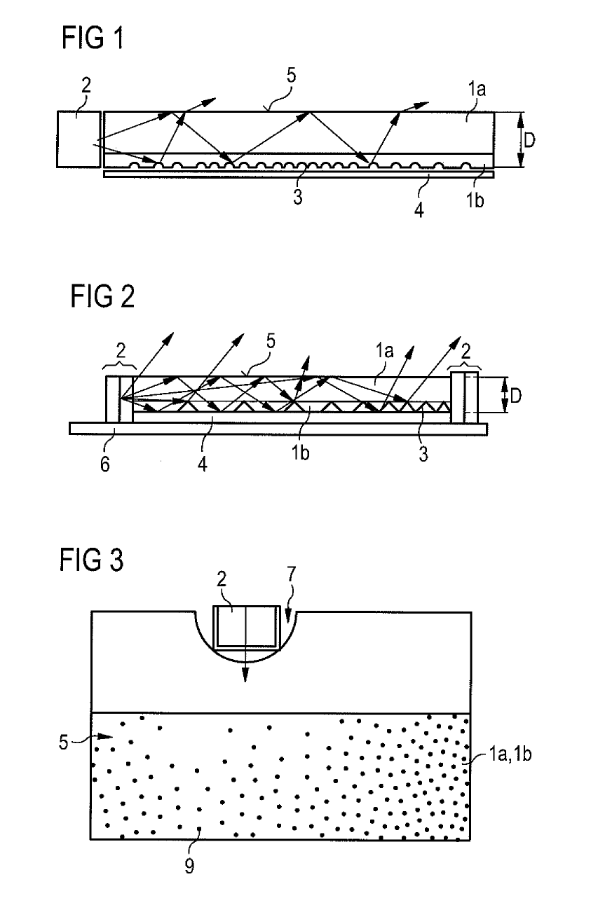

FIG. 1 shows a cross section of an optical arrangement comprising a light guide 1a, 1b and a light source 2 for illuminating the light guide 1a, 1b.

The light source 2 is arranged on a side surface of the light guide 1a, 1b. Preferably, the light source 2 is a light emitting diode (LED).

Compared to other illumination lamps, the use of an LED as light source has the advantage of a small dimension of the optical arrangement (light guide combined with light source). One advantageous feature of the optical arrangement is that it can be made very thin. This allows the optical arrangement to be used in very thin backlighted systems, for example in cell phone keypads or LCDs.

The light source 2 preferably emits light having a wavelength, for example in the blue, yellow, green or red spectral range. In the CIE color space, the preferred emitted light has, for example approximately a color point with the color locus about x=0.18 and y=0.12 (“crystal blue”) or about x=0.16 and y=0.20 (“blue lagune”) or about x=0.16 and y=0.34 (“green lagune”) or about x=0.40 and y=0.44 (“crystal yellow”) or about x=0.29 and y=0.17 (“magenta”) or about x=0.38 and y=0.24 (“crystal pink”). Therefore, six color varieties are available out of the wide color spectrum to provide a dedicated set of unsaturated colors.

The emitted light of the light source 2 is preferably coupled to the light guide 1a, 1b from the side surface. In this case, the light guide is an edge lit light guide. Thus, the optical arrangement is very thin compared to an optical arrangement comprising a light source which is arranged behind or in front of the light guide. The thickness of the optical arrangement comprising an edge lit light guide can in that way further get reduced.

The light guide 1a, 1b comprises a transparent substrate layer 1a and a transparent layer 1b. Further, the light guide has a light extraction surface 5 on a surface on the substrate layer 1a. The transparent layer 1b is arranged on the surface of the substrate layer 1a opposite to the light extraction surface 5. Further, the transparent layer 1b contains means for improving light extraction 3.

Because the light guide 1a, 1b comprises a transparent substrate layer 1a and a transparent layer 1b including means for improving light extraction 3, a uniform light extraction of the light guide can be provided. The light extraction is thereby optimized such that the light extraction of the light guide 1a, 1b over the complete light extraction surface 5 is nearly the same.

The light guide 1a, 1b has a thickness D of less than 300 μm, preferably a thickness D of less than 100 μm. Such a thin light guide 1a, 1b can advantageously be used as a backlight of keypads or displays. Preferably, the light guide 1a, 1b is used as a backlight for cell phone keypads or LCDs.

Therefore, it is very important that the light guide 1a, 1b is on the one hand very thin, has a high optical efficiency and is on the other hand very uniform across the light extraction surface 5.

The transparent layer 1b contains means for improving light extraction 3. The means for improving light extraction 3 preferably reflect or diffract the light to the light extraction surface 5. By the use of means for improving light extraction 3, the uniformity of the light extraction of the light guide 1a, 1b is optimized. The efficiency of the light extraction of the light guide is increased in this way.

Preferably, the means for improving light extraction 3 vary in density alongside the transparent layer 1b. The means for improving light extraction 3 can advantageously change in density to be optimized for point light sources 2, such as for example light emitting diodes (LEDs) or line sources at any side surface of the light guide 1a, 1b. Preferably, the density of the means for improving light extraction 3 increases within the distance from the light source 2. Thus, the means for improving light extraction 3 extract the light preferably uniformly in order to create a uniform backlight.

For example, the means for improving light extraction 3 are a prism array. In particular, the means for improving light extraction 3 are for example spherical, pyramidal or triangular holes or bumps. Alternatively, the means for improving light extraction 3 can be means for diffuse scattering, in particular etched dots. In this exemplary embodiment of the light guide 1a, 1b the means for improving light extraction 3 are spherical holes which are arranged on the surface of the transparent layer 1b opposite to the substrate layer 1a.

The means for improving light extraction 3 are preferably produced on the transparent layer 1b by means of embossing. Preferably, the means for improving light extraction 3 are produced on the transparent layer 1b by means of a roll to roll process.

A master for the means for improving light extraction 3 can be replicated and incorporated into a process that is roll to roll. Therefore, large stock rolls of the transparent substrate layer 1a can be used making the light guide 1a, 1b useable for mass production. Therewith, the production of the light guide 1a, 1b is very economical and very cost effective compared to injection molded light guides or the like.

The materials of the substrate layer 1a and of the transparent layer 1b are optically transmissive to the emitted light of the light source 2.

The transparent layer 1b is advantageously a curable layer. The transparent layer 1b is preferably curable by UV radiation. Preferably, the transparent layer is a polymer layer.

The transparent substrate layer 1a is preferably a plastic film. In particular, the material of the transparent layer 1b is index matched to the material of the substrate layer 1a or has a similar index. Thus, a preferably thin and flexible light guide 1a, 1b with a good light guidance can be provided.

The light propagation in the light guide 1a, 1b is shown in FIGS. 1 and 2 by means of arrows.

Preferably, the optical arrangement comprises a reflecting layer 4 which is arranged opposite to the light extraction surface 5 of the light guide 1a, 1b. Thus, the optical efficiency of the light guide 1a, 1b is improved.

FIG. 2 schematically shows a further cross section of an optical arrangement comprising a light guide 1a, 1b and light sources 2 for illuminating the light guide 1a, 1b.

In contrast to the embodiment of FIG. 1 the light guide is mounted on a carrier 6, for example a leadframe, a flex or a printed circuit board. Thus, the light guide 1a, 1b and the light sources 2 can be arranged on the carrier 6 wherein additionally the electrical connection of the light sources 2 is provided.

Between the light guide 1a, 1b and the carrier 6 a reflecting layer 4 is arranged. Thus, extracted light is reflected by the reflecting layer 4 and coupled out on the light extraction surface 5. The efficiency of the light guide 1a, 1b can be preferably increased in this way.

In contrast to the embodiment of FIG. 1 two light sources 2 are arranged on a side surface of the light guide 1a, 1b. In particular, the light sources 2 are arranged opposite to each other. Such an arrangement provides a preferred uniform light extraction. The light extraction of the light guide 1a, 1b has no significant variation over the complete light extraction surface 5.

To optimize extraction uniformity of the light guide 1a, 1b means for improving light extraction 3 are arranged on the surface of the transparent layer 1b which is opposite to the substrate layer 1a. The means for improving light extraction 3 of the embodiment of FIG. 2 are pyramidal holes which vary in their density depending on the distance to the light sources 2.

FIG. 3 shows a schematic top view of a further optical arrangement comprising a light guide 1a, 1b and a light source 2 for illuminating the light guide 1a, 1b.

In this embodiment, the light guide 1a, 1b contains means 7 for optical connecting the light source 2 to the light guide 1a, 1b. The means for optical connecting 7 can be produced in the light guide 1a, 1b by means of stamping or laser cutting.

The means for optical connecting 7 can be, for example, a cutout in the light guide. The cutout can be a dome wherein the dome is a depression. Preferably, the light source 2 is partly arranged in the dome so that the emitted light couples into the light guide 1a, 1b without significant optical loss.

Further, light extraction structures 9 are preferably arranged on the light extraction surface 5 of the light guide 1a, 1b. These light extraction structures 9 are, for example, three-dimensional structures. The light extraction structures 9 increase the uniformity and the efficiency of the light extraction which is coupled out of the light guide 1a, 1b. Furthermore, there can be a roughness of the light extraction surface 5 to further increase the uniformity and the efficiency of the light extraction.

The embodiment of the optical arrangement of FIG. 3 comprises the substantial features of the embodiment of the optical arrangements of FIGS. 1 and 2 except for the abovementioned differences.

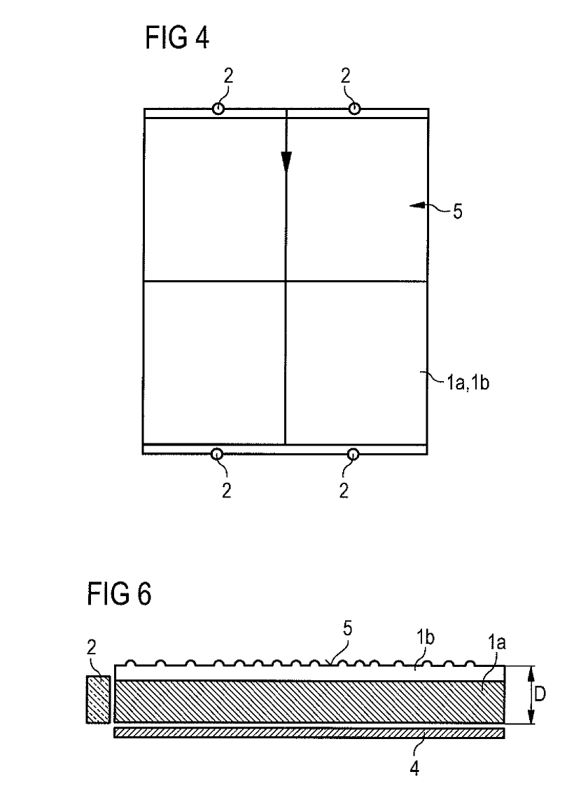

FIG. 4 shows a schematic top view of an optical arrangement comprising a light guide 1a, 1b and light sources 2 for illuminating the light guide 1a, 1b.

This embodiment of an optical arrangement 1a, 1b comprises multiple light sources 2 which are arranged on side surfaces of the light guide 1a, 1b. In particular, two light sources 2, particularly LEDs, are arranged on one side surface of the light guide 1a, 1b. Opposite to this side surface two further LEDs 2 are arranged on the opposite side surface. Thus, two LEDs 2 are in each case arranged oppositely to each other.

Multiple light sources 2 can optimize the uniform light extraction of the light guide 1a, 1b. Preferably, multiple LEDs 2 are arranged on both side surfaces of the light guide. In particular, at least two LEDs 2 can be arranged on each side surface of the light guide, e.g. oppositely to each other. In this way, an optical uniform light extraction can be provided. The light extraction of the light guide 1a, 1b is thereby over the complete light extraction surface 5 nearly the same.

The embodiment of the optical arrangement of FIG. 4 comprises the substantial features of the embodiment of the optical arrangements of FIGS. 1, 2 and 3 except for the abovementioned differences.

In FIGS. 5A, 5B, 5C preferably schematic perspective views of means for improving light extraction 3 are shown.

In FIG. 5A a spherical hole is shown. The spherical hole has, for example, a height h of about 15 μm. The cross section dimension of the spherical hole is, for example about 50 μm.

The means for improving light extraction 3 of FIG. 5B is a three-dimensional tetragon prism hole. Each side length of the base of the tetragon prism hole is, for example, about 71 μm. The height h of the tetragon prism is, as the height of the example of FIG. 5A, about 15 μm. The included angle α between the base and two opposite side surfaces of the tetragon prism is about 45°.

In FIG. 5C a pyramidal hole is shown. Equally to the example of FIG. 5B the base length is about 71 μm and the height h is about 15 μm. The included angle α between the base and each side surface is in each case about 45°.

By the use of means for improving light extraction 3 based on the examples of FIGS. 5A-5C, the uniformity of the light extraction of the light guide can get optimized. Such means for improving light extraction 3 extract the light preferably uniformly in order to create a uniform backlight.

The means for improving light extraction 3 are preferably produced on the transparent layer by means of embossing. Preferably, the means for improving light extraction 3 are produced on the transparent layer by means of a roll to roll process.

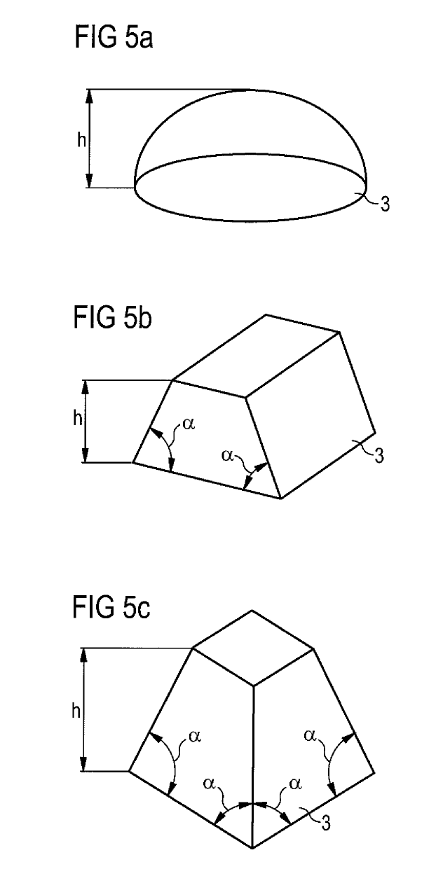

FIG. 6 schematically shows a cross section of a further optical arrangement comprising a light guide 1a, 1b and a light source 2 for illuminating the light guide 1a, 1b.

In contrast to the embodiment of FIG. 1 the transparent layer 1b is arranged on the light extraction surface 5 of the transparent substrate 1a.

In this exemplary embodiment of the light guide 1a, 1b the means for improving light extraction 3 are spherical bumps which are arranged on the surface of the transparent layer 1b opposite to the substrate layer 1a.

This patent application claims the priority of U.S. Provisional Patent Application 61/066,719, the disclosure content of which is hereby incorporated by reference.

The above description of the invention using the exemplary embodiments is not to be understood to mean a restriction of the invention thereto. Rather, the inventive concept set out in claims 1 and 11 can be applied for a large number of very different designs. In particular, the invention also covers all combinations of the features cited in the exemplary embodiments and in the rest of the description, even if these combinations are not the subject matter of a patent claim.

1. An optical arrangement comprising:
a light guide; and
a light source for illuminating the light guide,
wherein the light guide comprises a transparent substrate layer and a transparent layer,
wherein the light guide has a light extraction surface on a surface of the substrate layer,
wherein the transparent layer is arranged on the surface of the substrate layer opposite to the light extraction surface, or the transparent layer is arranged on the light extraction surface of the substrate layer, and
wherein the transparent layer contains means for improving light extraction.

2. The optical arrangement as claimed in claim 1, wherein the light guide is less than 300 μm thick.

3. The optical arrangement as claimed in claim 1, wherein the light source or multiple light sources are arranged on at least one side surface of the light guide.

4. The optical arrangement as claimed in claim 1, wherein the means for improving light extraction vary in density alongside the transparent layer.

5. The optical arrangement as claimed in claim 1, wherein the means for improving light extraction are a prism array.

6. The optical arrangement as claimed in claim 1, wherein the transparent layer is a curable layer or a polymer layer.

7. The optical arrangement as claimed in claim 1, wherein the substrate layer is a plastic film.

8. The optical arrangement as claimed in claim 1, wherein the material of the transparent layer is index matched to the material of the substrate layer.

9. The optical arrangement as claimed in claim 1, wherein the light source is an LED.

10. The optical arrangement as claimed in claim 1, wherein the light guide contains means for optical connecting the light source to the light guide.

11. A method for the production of a light guide comprising:
providing a transparent substrate layer;
arranging a transparent layer on the surface of the substrate layer opposite to a light extraction surface, or arranging a transparent layer on the light extraction surface of the substrate layer;
producing means for improving light extraction on the transparent layer; and
mounting the light source on a surface of the light guide.

12. The method of claim 11, wherein the means for improving light extraction are produced on the transparent layer by means of embossing.

13. The method of claim 11, wherein the means for improving light extraction are produced on the transparent layer by means of a roll to roll process.

14. The method of claim 11, wherein the transparent layer is cured by UV radiation.

15. The method of claim 11, wherein means for optical connecting the light source to the light guide are produced in the light guide by means of stamping or laser cutting.
